(19) United States
(12) Patent Application Publication
(10) Pub. No.: US 2025/0238176 A1
(43) Pub. Date: Jul. 24, 2025

(54) IMAGE PROCESSING APPARATUS FOR OUTPUTTING IMAGE DATA, METHOD FOR CONTROLLING IMAGE PROCESSING APPARATUS, AND STORAGE MEDIUM

(71) Applicant: CANON KABUSHIKI KAISHA, Tokyo (JP)

(72) Inventor: Eri OKUDA, Ibaraki (JP)

(21) Appl. No.: 19/006,367

(22) Filed: Dec. 31, 2024

(30) Foreign Application Priority Data
Jan. 19, 2024 (JP) 2024-006580

(51) Int. Cl. G06F 3/12; G06F 3/14

(52) U.S. Cl. CPC G06F 3/1242; G06F 3/14

(57) ABSTRACT

Structures capable of changing output processing according to a result of a determination whether or not image data to be output is generated on the basis of a learning model, are provided. An image processing apparatus determines whether or not image data input by input processing is generated on the basis of a learning model. In a case where it is determined that the image data is generated on the basis of a learning model, the image processing apparatus does not execute output processing on the image data, or adds processing to the image data and then executes output processing on the image data to which the processing is added.

### BACKGROUND OF THE INVENTION

### Field of the Invention

The present invention relates to image processing apparatuses, method for controlling image processing apparatuses, and storage media.

### Description of the Related Art

In recent years, image generation technology using Artificial Intelligence (AI) has become widespread. This has made it possible for individuals to easily generate realistic images, for example. On the other hand, AI-based image generation technology is also increasingly used for malicious purposes, which is becoming a problem. For example, photographs of fictitious cases and accidents relating to real persons, facilities, and the like are fabricated.

In order to prevent such abuse of the AI-based image generation technology, various countries are working to quickly prepare laws and development guidelines for AI-generated content. For example, one such law is being considered that would require AI-generated content to be explicitly stated as being generated by AI. In the future, it is likely that a clear distinction will be required between AI-generated content and other content.

Japanese Laid-Open Patent Publication (kokai) No. 2000-175031 discloses an image processing apparatus equipped with measures to prevent malicious use of image data by limiting the output onto sheets, storage, and transfer to external devices for image data such as banknotes and securities, which are generally prohibited from being copied. It is considered that such image processing apparatuses may also need to be limited in processing of images generated using AI.

However, the image processing apparatus described in Japanese Laid-Open Patent Publication (kokai) No. 2000-175031 does not determine whether or not an image was generated using AI, even when it is necessary to make such a determination, and there is room for improvement in this regard.

### SUMMARY OF THE INVENTION

The present invention provides systems capable of executing output processing of outputting image data, and when it is necessary or requested to determine whether or not an image to be output is generated on the basis of a learning model, changing the output processing according to a result of the determination.

According to an aspect of the invention, an image processing apparatus includes: an input unit configured to execute input processing of inputting image data; a determination unit configured to make a determination whether or not the image data input by the input processing is generated on the basis of a learning model; and an output unit. The output unit is configured to not execute output processing of outputting the image data in a case where it is determined by the determination unit that the image data is generated on the basis of the learning model, and is configured to execute the output processing in a case where it is determined by the determination unit that the image data is not generated on the basis of the learning model.

According to another aspect of the invention, an image processing apparatus includes: an input unit configured to execute input processing of inputting image data; and a determination unit configured to make a determination whether or not the image data input by the input processing is generated on a basis of a learning model. The image processing apparatus further includes: a processing unit configured to add processing to the image data in a case where it is determined that the image data-is generated on a basis of the learning model; and an output unit configured to execute output processing of outputting the image data to which the processing is added.

According to another aspect of the invention, a method for controlling an image processing apparatus, includes: executing input processing of inputting image data; and determining whether or not the image data input by the input processing is generated on a basis of a learning model. The method further includes: not executing output processing of outputting the image data in a case where it is determined that the image data is generated on a basis of the learning model; and executing the output processing in a case where it is determined that the image data is not generated on a basis of the learning model.

According to another aspect of the invention, a method for controlling an image processing apparatus, includes: executing input processing of inputting image data; and determining whether or not the image data input by the input processing is generated on a basis of a learning model. The method further includes: in a case where it is determined that the image data generated on a basis of the learning model, adding processing to the image data and executing output processing of outputting the image data to which the processing is added.

According to the present invention, in a case where it is necessary or requested to determine whether or not an image to be output is generated on the basis of a learning model when an image processing apparatus executes output processing on image data, the output processing can be changed according to a result of the determination.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of an image processing system according to a first embodiment.

FIG. 2 is a block diagram illustrating a hardware configuration of an AI-based image generation server.

FIG. 3 is a block diagram illustrating a hardware configuration of a general-purpose terminal.

FIGS. 4A and 4B are flowcharts illustrating processing executed by the general-purpose terminal and processing executed by the AI-based image generation server.

FIG. 5 is a block diagram illustrating another hardware configuration of the image processing system.

FIG. 6 is a block diagram illustrating a hardware configuration of an image processing apparatus.

FIG. 7 is a block diagram illustrating a hardware configuration of a controller unit included in the image processing apparatus.

FIG. 8 is a flowchart illustrating processing executed by the image processing apparatus (processing of limited printing for AI-generated images).

FIG. 9 is a diagram illustrating an example of a notification screen displayed on the image processing apparatus.

FIGS. 10A and 10B are diagrams illustrating examples of printed matters printed by the image processing apparatus.

FIG. 11 is a diagram illustrating an example of an operation screen displayed on the image processing apparatus when limited printing is performed.

FIG. 12 is a flowchart illustrating processing executed by the general-purpose terminal (print job processing of limited printing for AI-generated images).

FIG. 13 is a flowchart illustrating a modification of processing executed by the general-purpose terminal (print job processing of limited printing for AI-generated images).

FIG. 14 is a flowchart illustrating processing executed by an image processing apparatus (processing of limited transmission for AI-generated images) according to a second embodiment.

FIG. 15 is a diagram illustrating an example of a notification screen displayed on the image processing apparatus.

FIGS. 16A and 16B are diagrams illustrating examples of a printed matter printed by a printing apparatus in a case where an apparatus other than the image processing apparatus is the printing apparatus.

FIG. 17 is a diagram illustrating an example of an operation screen displayed on the image processing apparatus when limited transmission is performed.

FIG. 18 is a flowchart illustrating processing executed by the general-purpose terminal (transmission job processing of limited transmission for AI-generated images).

FIG. 19 is a flowchart illustrating a modification of processing executed by the general-purpose terminal (transmission job processing of limited transmission for AI-generated images).

### DESCRIPTION OF THE EMBODIMENTS

The present invention will now be described in detail below with reference to the accompanying drawings showing embodiments thereof.

The configurations described in the following embodiments are merely examples, and the scope of the present invention is not limited by the configurations described in the embodiments. For example, each unit constituting the present invention can be replaced with one having any configuration capable of exhibiting similar functions. In addition, any component may be added the configurations described in the embodiments. Further, any two or more configurations (features) in the embodiments may be combined.

### First Embodiment

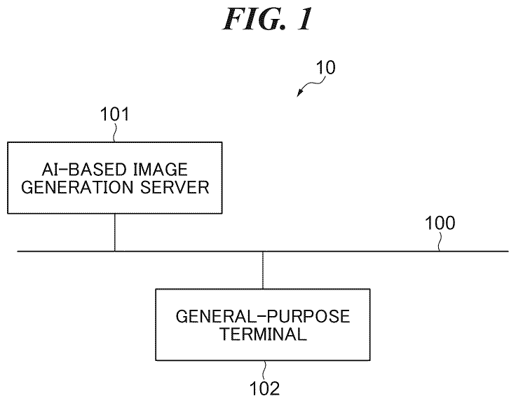

Hereinafter, a first embodiment will be described with reference to FIGS. 1 to 13.

FIG. 1 is a block diagram illustrating a hardware configuration of an image processing system according to the first embodiment. As illustrated in FIG. 1, the image processing system 10 includes an AI-based image generation server 101 and a general-purpose terminal 102, which are communicably connected to each other via a network 100.

The AI-based image generation server 101 is an external apparatus that generates image data on the basis of a machine learning model or a learning model. Hereinafter, generating image data on the basis of a learning model (including a trained learning model) may be referred to as “AI-based image generation”. The generated image data is transmitted to the general-purpose terminal 102. The general-purpose terminal 102 is a device capable of executing various types of processing on image data transmitted from the AI-based image generation server 101. The general-purpose terminal 102 is not limited to any particular computing device, and can be, for example, a desktop or laptop personal computer, a tablet terminal, a smartphone, or the like. It should be noted that the AI-based image generation is performed by the AI-based image generation server 101 in the present embodiment but is not limited thereto, and may be performed by the general-purpose terminal 102, for example.

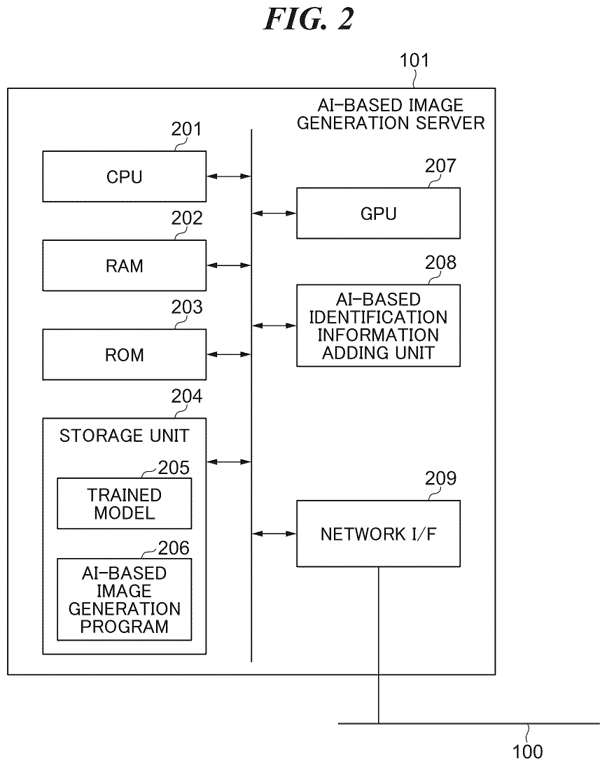

FIG. 2 is a block diagram illustrating a hardware configuration of the AI-based image generation server 101. As illustrated in FIG. 2, the AI-based image generation server 101 includes a CPU 201, a RAM 202, a ROM 203, a storage unit 204, a GPU 207, an AI-based identification information adding unit 208, and a network interface (I/F) 209.

The CPU 201 controls operation of the AI-based image generation server 101 on the basis of a program developed in the RAM 202. The ROM 203 is a boot ROM, and stores, for example, a boot program for the image processing system 10. The storage unit 204 is a nonvolatile device including an HDD, an SSD, or the like. The storage unit 204 stores a trained model 205 to be used in AI-based image generation, an AI-based image generation program 206, and the like. It should be noted that, in the AI-based image generation, any trained model 205 and an existing AI-based image generation program 206 such as Stable Diffusion can be used, but it is not limited to the use of them. The trained model 205 and the AI-based image generation program 206 are loaded into the RAM 202 and executed by the CPU 201. Since the technology related to the AI-based image generation is a known technology, its description is omitted here.

The AI-based image generation is executed in response to a request for AI-based image generation from the general-purpose terminal 102. The CPU 201 instructs the GPU 207 to respond to the request. The GPU 207 performs AI-based image generation according to the given instructions. Thus, image data is generated.

The image data includes identification information that makes it possible to identify image data generated by AI-based image generation, that is, identification information identifying the image data as being generated on the basis of a learning model. Such identification information is added to the image data by the AI-based identification information adding unit 208. It should be noted that identification information may further include, for example, information regarding the trained model 205 and the AI-based image generation program 206, information regarding a request for AI-based image generation, and the like. In addition, identification information may be provided as metadata similarly to header information or the like of an image file, or may be provided as information superimposed on the image itself, like an invisible electronic watermark or text to be visualized.

The network I/F 209 is connected to the network 100 and is used for inputting and outputting various types of information. The connection between the network I/F 209 and the network 100 can be wired or wireless.

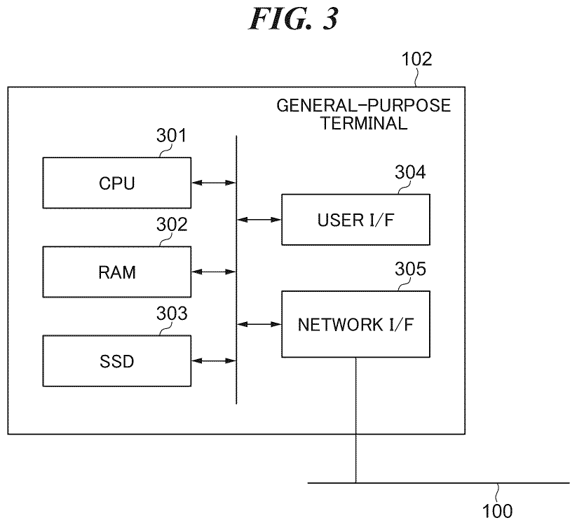

FIG. 3 is a block diagram illustrating a hardware configuration of the general-purpose terminal 102. As illustrated in FIG. 3, the general-purpose terminal 102 includes a CPU 301, a RAM 302, an SSD 303, a user I/F 304, and a network I/F 305.

The CPU 301 controls operation of the general-purpose terminal 102 on the basis of a program developed in the RAM 302. The SSD 303 stores various programs and the like. The programs include, for example, a system program, an AI-based image generation application, and the like. The user I/F 304 includes, for example, a display, a touch panel, a keyboard, a mouse, and the like, and performs input/output processing for users. The network I/F 305 is connected to the network 100 and is used for inputting and outputting various types of information. The connection between the network I/F 305 and the network 100 can be wired or wireless. It should be noted that the general-purpose terminal 102 may have, for example, a telephone function, a camera function, or the like.

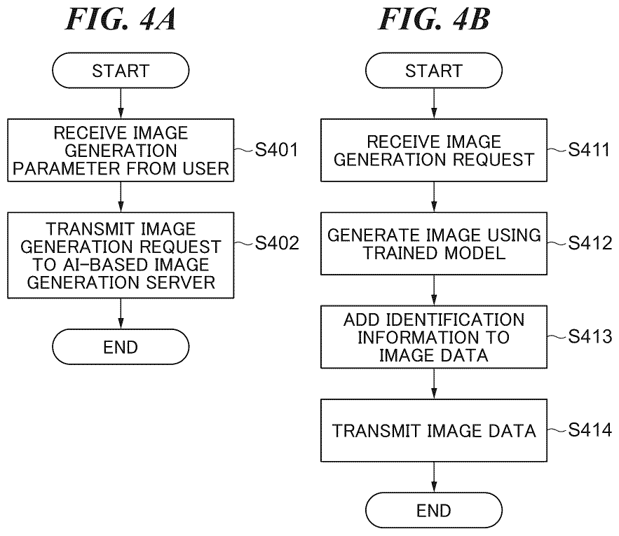

FIG. 4A is a flowchart illustrating processing executed by the general-purpose terminal 102. FIG. 4B is a flowchart illustrating processing executed by the AI-based image generation server 101. As illustrated in FIG. 4A, in step S401, the CPU 301 of the general-purpose terminal 102 determines that parameters for an image to be generated by the AI-based image generation server 101 have been received from a user via the user I/F 304. These parameters are not particularly limited, and can be information or data used in a known AI-based image generation technology, such as keywords, sentences, and images related to the image.

In step S402, the CPU 301 transmits an image generation request based on the parameters received in step S401 to the AI-based image generation server 101 via the network I/F 305.

As illustrated in FIG. 4B, in step S411, the CPU 201 of the AI-based image generation server 101 determines that the image generation request transmitted in step S402 has been received via the network I/F 209.

In step S412, the CPU 201 controls the GPU 207 to perform AI-based image generation using the trained model 205 as described above.

In step S413, the CPU 201 controls the AI-based identification information adding unit 208 to add identification information to image data generated in step S412. Hereinafter, image data obtained using AI-based image generation may be referred to as “AI image data”. In addition, an AI image data to which identification information is added may be referred to as “image data with identification information”.

In step S414, the CPU 201 transmits the image data to which the identification information is added in step S413 to the general-purpose terminal 102 via the network I/F 209. Thus, the general-purpose terminal 102 receives the image data with identification information.

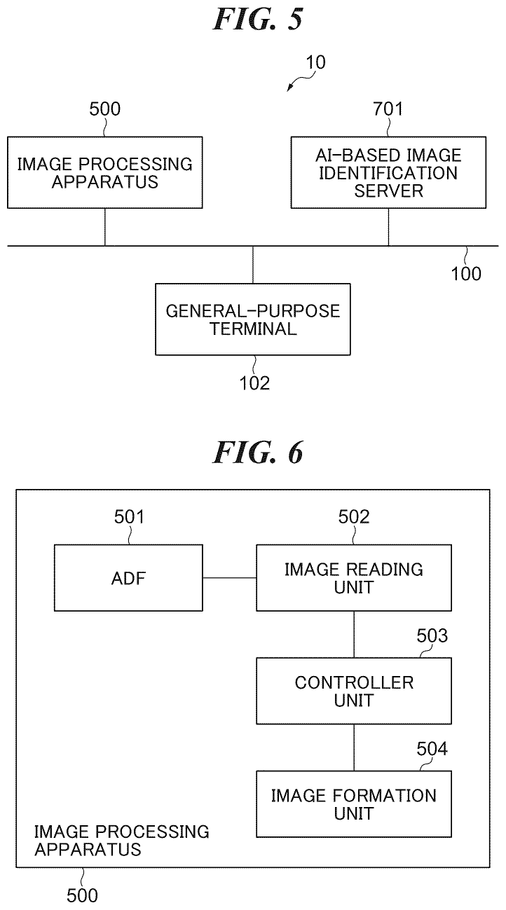

FIG. 5 is a block diagram illustrating a hardware configuration of the image processing system 10 in another situation. As illustrated in FIG. 5, in the image processing system 10, the general-purpose terminal 102 is connected to an image processing apparatus 500 and an AI-based image identification server 701 via the network 100.

In the general-purpose terminal 102, an application capable of inputting a remote job to the image processing apparatus 500 is installed. The application is not particularly limited, and may be, for example, a driver application for the image processing apparatus 500, or may be a mobile application supporting the image processing apparatus 500 in a case where the general-purpose terminal 102 is a tablet terminal or the like.

In the AI-based image identification server 701, an AI-based image identification application using a known technology (for example, a learning model by machine learning) is installed. With the application, the AI-based image identification server 701 analyzes image data input via the network 100 and determines whether or not the image data is created by the AI-based image generation technology. Then, the AI-based image identification server 701 notifies the general-purpose terminal 102 of the determination result.

It should be noted that, in the present embodiment, the general-purpose terminal 102 is connected to the AI-based image generation server 101 via the network 100 in one situation, and the image processing apparatus 500 and the AI-based image identification server 701 via the network 100 in another situation, but is not limited thereto. For example, the network connecting the general-purpose terminal 102 and the AI-based image generation server 101 may be different from the network connecting the general-purpose terminal 102, the image processing apparatus 500, and the AI-based image identification server 701.

FIG. 6 is a block diagram illustrating a hardware configuration of the image processing apparatus 500. As illustrated in FIG. 6, the image processing apparatus 500 includes an automatic document feeder (ADF) 501, an image reading unit 502, a controller unit 503, and an image formation unit 504.

The ADF 501 transmits and receives a control signal to and from the image reading unit 502 via a data bus, and conveys a document. Further, the ADF 501 includes various sensors such as a document detection sensor that detects a document, and notifies a value of each sensor when the document is conveyed. The image reading unit 502 reads a document together with the ADF 501 in accordance with a document reading instruction received from the controller unit 503 via the data bus.

The controller unit 503 controls the entire image processing apparatus 500 including the ADF 501, the image reading unit 502, and the image formation unit 504 via the data bus. In addition, the controller unit 503 executes input processing of inputting image data, analyzes the input image data, performs image processing as appropriate, and generates image data to be output.

The image formation unit 504 prints image data acquired from the controller unit 503 via the data bus as a visible image on a recording sheet while conveying the recording sheet. This printed matter is discharged from the image processing apparatus 500. In this way, in the present embodiment, the image formation unit 504 functions as an output unit (print engine) capable of executing printing processing of printing image data, which is output processing of outputting the image data.

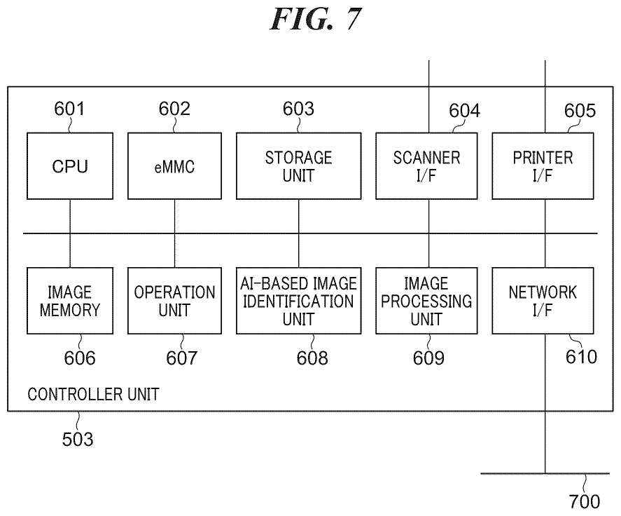

FIG. 7 is a block diagram illustrating a hardware configuration of the controller unit 503 included in the image processing apparatus 500. As illustrated in FIG. 7, the controller unit 503 includes a CPU 601, an eMMC 602, a storage unit 603, a scanner I/F 604, a printer I/F 605, an image memory 606, an operation unit 607, an AI-based image identification unit 608, an image processing unit 609, and a network I/F 610.

The CPU 601 is a computer that controls the entire image processing apparatus 500. The eMMC 602 includes a flash memory and stores control programs executed by the CPU 601. The control programs include, for example, programs for causing a computer to execute procedures for implementing the functions of units of the image processing apparatus 500 and/or procedures for controlling the image processing apparatus 500.

The storage unit 603 is a nonvolatile memory for holding information to be used for various types of control. The scanner I/F 604 transmits and receives data to and from the image reading unit 502. The printer I/F 605 transmits and receives data to and from the image formation unit 504. The image memory 606 stores image data and the like acquired via the scanner I/F 604. The operation unit 607 is a user interface and includes a touch panel and a hard key. For example, the touch panel displays information for users, and accepts operations for job input and various settings by users.

The AI-based image identification unit 608 determines, prior to output processing, whether or not image data input by input processing, for example, image data transmitted from the general-purpose terminal 102, is made by AI-based image generation. This determination is made on the basis of identification information (on the basis of whether or not the image data includes identification information). Specifically, in a case where identification information is included in image data which is a determination target, that is, in a case where identification information is provided with the image data, the AI-based image identification unit 608 determines that the image data as a determination target is made by AI-based image generation. On the other hand, in a case where identification information is not included in the image data as a determination target, that is, in a case where no identification information is provided with the image data, the AI-based image identification unit 608 determines that the image data as a determination target is not generated by AI-based image generation.

The image processing unit 609 processes image data. The network I/F 610 is connected to the network 100 and controls input and output of various types of information, image data, and the like.

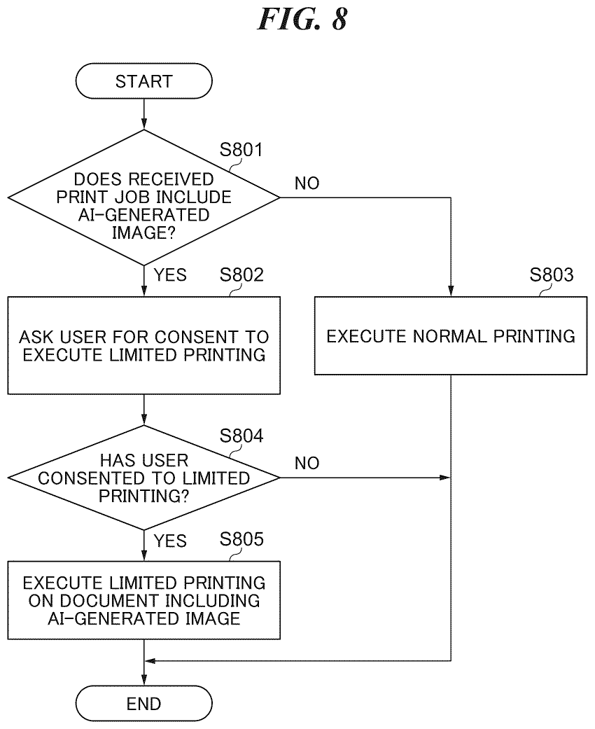

FIG. 8 is a flowchart illustrating processing executed by the image processing apparatus 500 (processing of limited printing for AI-generated images). When a print job sent from an external apparatus such as the general-purpose terminal 102 via the network 100 is received by the network I/F 610, the image processing apparatus 500 starts execution of the print job. The print job includes information to be used by the image processing apparatus 500 to perform printing, such as the output size and resolution, as well as image data.

In step S801, the CPU 601 (controller unit 503) of the image processing apparatus 500 controls the AI-based image identification unit 608 to determine whether or not AI image data (AI-generated image) is included in the print job received by the network I/F 610 (whether or not image data of the print job includes an AI-generated image). Specifically, after execution of input processing of inputting the image data of the print job, the AI-based image identification unit 608 refers to metadata of the image data as a determination target in the print job and performs image analysis to determine whether or not the image data includes identification information that indicates whether or not the image data is AI image data. In a case where the image data includes identification information, the AI-based image identification unit 608 determines that the print job includes AI image data. In a case where the image data does not include identification information, the AI-based image identification unit 608 determines that the print job does not include AI image data. Then, as a result of the determination in step S801, in a case where it is determined that the print job includes AI image data, the processing proceeds to step S802. At this time, the identification information is stored in the storage unit 603. On the other hand, as a result of the determination in step S801, in a case where it is determined that the print job does not include AI image data, the processing proceeds to step S803.

It should be noted that, in the present embodiment, the determination as to whether or not the print job includes AI image data is made on the basis of the presence or absence of identification information, but is not limited thereto. For example, identification information can be digitized by a probability, a score, or the like indicating how likely a specific portion of the image data (image) as a determination target is to be AI image data (AI-generated image). In this case, the AI-based image identification unit 608 converts the identification information into a percentage value, and determines that the print job includes AI image data when the resulting numerical value of the identification information is equal to or greater than a threshold value (N %). When the resulting numerical value of the identification information is less than the threshold value (N %), the AI-based image identification unit 608 determines that the print job does not include AI image data.

The threshold value may be stored in advance in the storage unit 603, may be included in the print job, or may be set via the operation unit 607 before the job is executed. In addition, the threshold value is preferably changeable to suit the situation.

In a case where the entire image of the image data as a determination target is not an AI-generated image but a part of the image is an AI-generated image, identification information may include information for specifying an AI-generated image portion. The information for specifying the AI-generated image portion may be indicated by, for example, the upper left coordinates and the lower right coordinates of the AI-generated image portion, or may be information on pixels constituting the AI-generated image portion.

In the present embodiment, the determination as to whether or not the print job includes AI image data is performed by the AI-based image identification unit 608 but is not limited thereto, and may be performed by the AI-based image identification server 701, for example.

In step S803, the CPU 601 controls the image formation unit 504 to execute a print job, that is, execute normal printing processing assuming that a document including no AI-generated image is input. After execution of step S803, the processing ends.

In step S802, the CPU 601 notifies a user who uses the image processing apparatus 500 that an AI-generated image is included in the document to be printed, and notifies whether to perform the limited printing or to stop the printing.

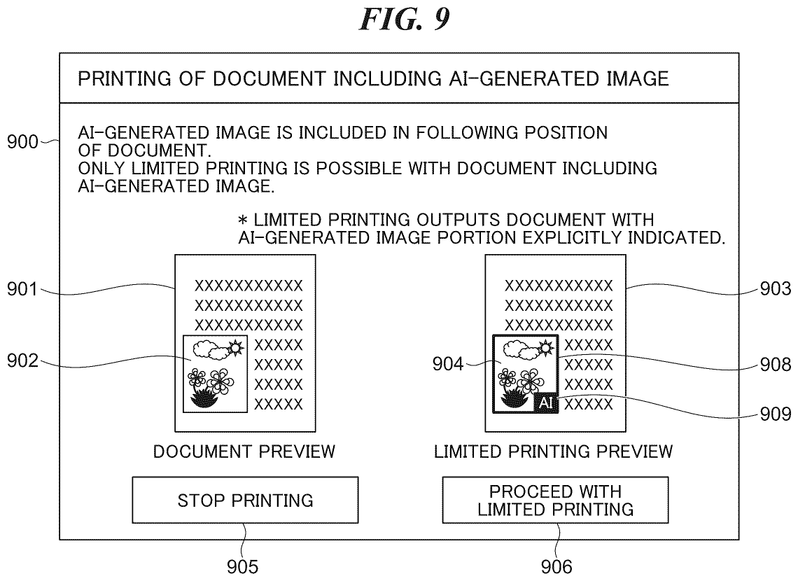

FIG. 9 is a diagram illustrating an example of a notification screen displayed on the image processing apparatus 500. A notification screen 900 illustrated in FIG. 9 is displayed on the touch panel of the operation unit 607. The notification screen 900 includes a preview image 901, a preview image 903, a stop printing button 905, and a proceed with limited printing button 906. The preview image 901 is an image representing a document image as it is. The preview image 901 includes a partial image 902 that is an AI-generated image. The preview image 903 is an image indicating an output result prediction when limited printing is performed. The preview image 901 and the preview image 903 are provided for comparison.

The preview image 903 includes a partial image 904 that is an AI-generated image. The partial image 904 includes an image frame 908 and characters 909 of “AI” superimposed thereon as information indicating that it is an AI-generated image. This allows users to understand that, when the image data is printed, it provides a printed matter on which the same image as the preview image 903 is printed. It should be noted that the character 909 is “AI”, but is not limited thereto, and may be any character indicating that it is an AI-generated image.

The partial image 902 and the partial image 904 are determined on the basis of the identification information stored in the storage unit 603 in step S801. The preview image 901 and the preview image 903 completely coincide with each other in a case where an AI-generated image is not included in the document image or in a case where the entire document image is indicated as being an AI-generated image.

In step S804, the CPU 601 determines whether or not the proceed with limited printing button 906 has been operated on the notification screen 900 displayed in step S802. As a result of the determination in step S804, in a case where it is determined that the proceed with limited printing button 906 has been operated, the processing proceeds to step S805. On the other hand, as a result of the determination in step S804, in a case where it is determined that the proceed with limited printing button 906 has not been operated, that is, the stop printing button 905 has been operated, the printing processing (output processing) is not executed, and the processing is terminated.

In step S805, the CPU 601 controls the image formation unit 504 to perform limited printing. Specifically, the CPU 601 refers to the identification information stored in the storage unit 603 and an output pattern setting for the limited printing. Then, the CPU 601 controls the image processing unit 609 to perform image processing of adding processing according to the output pattern setting to the AI-generated image portion included in the document image. Thereafter, the CPU 601 controls the image formation unit 504 to output the image processed (in other word, modified) by the image processing unit 609. Thus, a printed matter is obtained on which the same image as the preview image 903 is printed. After execution of step S805, the processing ends.

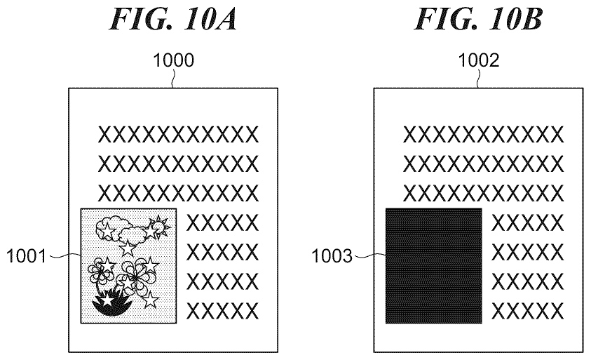

FIGS. 10A and 10B are diagrams illustrating examples of printed matters printed by the image processing apparatus 500. In a printed matter 1000 illustrated in FIG. 10A, a partial image 1001 that is an AI-generated image has a very light color on the entire image, and has marks such as stars superimposed on the image, for example. With such image processing, viewers of the printed matter 1000 can understand that the partial image 1001 is an AI-generated image. In a printed matter 1002 illustrated in FIG. 10B, a partial image 1003, which is an AI-generated image, is an image filled in black. With such image processing, viewers of the printed matter 1002 can understand that the printed matter 1002 is a printed matter including an AI-generated image. It should be noted that a printed matter including an AI-generated image is not limited to the printed matter 1000 and the printed matter 1002, and may be a printed matter in which, for example, invisible information such as an electronic watermark is superimposed on the entire image or a partial image. Further, information indicating that it is a printed matter including an AI-generated image may be set in advance by an administrator of the image processing apparatus 500 and stored in the storage unit 603, or may be set by a user and stored in the storage unit 603.

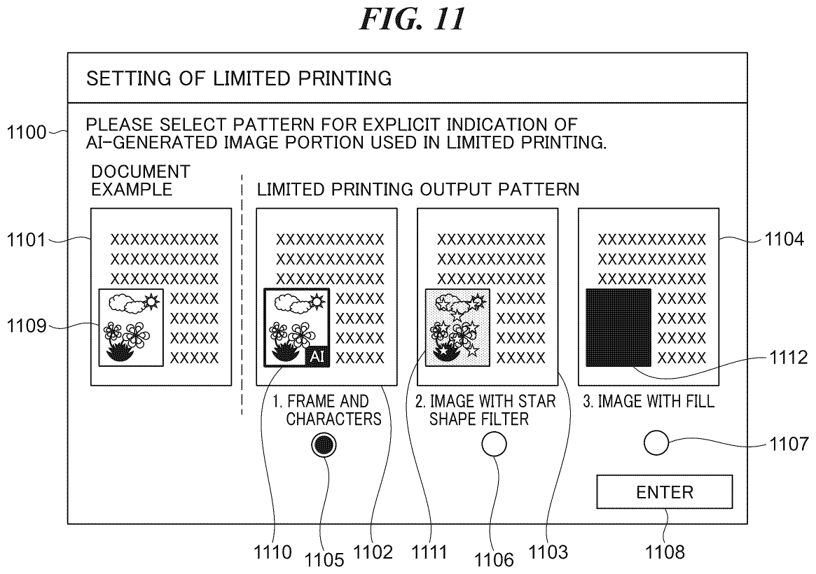

FIG. 11 is a diagram illustrating an example of an operation screen displayed on the image processing apparatus at the time of limited printing. An operation screen 1100 illustrated in FIG. 11 is displayed on the touch panel of the operation unit 607. The operation screen 1100 includes preview images 1101 to 1104, radio buttons 1105 to 1107, and an enter button 1108.

The preview image 1101 is an image representing a document image as it is. The preview image 1101 includes a partial image 1109 that is an AI-generated image. The preview image 1102 is an image (first output pattern) indicating an output result prediction in a case where limited printing is performed. The preview image 1102 includes a partial image 1110 that is an AI-generated image. The partial image 1110 is similar to the partial image 904. The preview image 1103 is an image (second output pattern) indicating an output result prediction in a case where limited printing is performed. The preview image 1103 includes a partial image 1111 that is an AI-generated image. The partial image 1111 is similar to the partial image 1001. The preview image 1104 is an image (third output pattern) indicating an output result prediction in a case where limited printing is performed. The preview image 1104 includes a partial image 1112 that is an AI-generated image. The partial image 1112 is similar to the partial image 1003.

The radio button 1105 is selected by a user when it is desired to obtain a printed matter on which the same image as the preview image 1102 is printed. The radio button 1106 is selected by a user when it is desired to obtain a printed matter on which the same image as the preview image 1103 is printed. The radio button 1107 is selected by a user when it is desired to obtain a printed matter on which the same image as the preview image 1104 is printed. A user is allowed to select one of the radio buttons 1105 to 1107 and then operate the enter button 1108. Thus, a printed matter of the preview image corresponding to the selected radio button is obtained.

As described above, in the image processing apparatus 500, input processing of inputting image data is executed, and then a determination whether or not the input image data is made by AI-based image generation is made by the AI-based image identification unit 608. A result of the determination by the AI-based image identification unit 608 can be a case where it is determined that the image data as a printing processing (output processing) target is made by AI-based image generation or a case where it is determined that the image data is not made by AI-based image generation. When it is necessary or requested to determine whether or not image data to be output is AI image data, the image processing apparatus 500 is capable of changing the printing processing according to a result of the determination. Hereinafter, a case where image data as a printing processing (output processing) target is determined as being generated by AI-based image generation is referred to as a “first case”, and a case where image data as a printing processing (output processing) target is determined as not being generated by AI-based image generation is referred to as a “second case”.

In the first case, the CPU 601 (controller unit 503) of the image processing apparatus 500 adds processing to image data as a printing processing target, and controls the image formation unit 504 to output the processed image data, thereby executing the printing processing. When adding the processing to the image data, the CPU 601 performs processing on the image data so as to visualize that the printed matter acquired by the printing processing is a printed matter of image data including identification information. In other words, the CPU 601 adds processing to the image data so as to visualize that the image data includes the identification information in a printed matter of the image data acquired by the printing processing. Thus, a printed matter is obtained on which, for example, the same image as the preview image 903 (see FIG. 9) or the printed matter 1000 (see FIG. 10A) is printed. The partial image 904 of the preview image 903 includes the image frame 908 and the characters 909 of “AI” superimposed thereon. The partial image 1001 of the printed matter 1000 has very light color applied on the entire image, and has marks such as stars superimposed on the image. Alternatively, no printing processing may be executed on an AI image portion. Thus, a printed matter is obtained on which, for example, the same image as the printed matter 1002 (see FIG. 10B) is printed. The partial image 1003 of the printed matter 1002 is an image filled with black. These kinds of printed matters make viewers aware that the printed matters include AI images. This gives viewers of the printed matters a way to, for example, suspect that the AI images may be fake.

It should be noted that, in the first case, the image processing apparatus 500 may be configured so as not to perform the limited printing (output processing).

On the other hand, in the second case, the CPU 601 of the image processing apparatus 500 does not add the processing to the image data as a printing processing target via the image processing unit 209, and performs the printing processing on the image data as it is via the image formation unit 504.

In the present embodiment, the image processing system 10 has a configuration in which the AI-based image identification unit 608 is included in the image processing apparatus 500, but may have a configuration in which, for example, an AI-based image identification unit having a function similar to that of the AI-based image identification unit 608 (hereinafter referred to as “terminal AI-based image identification unit”) is included in the general-purpose terminal 102. Here, a description will be given mainly of the differences from the above-described configuration in which the AI-based image identification unit 608 is included in the image processing apparatus 500, and similar matters will be omitted from the description.

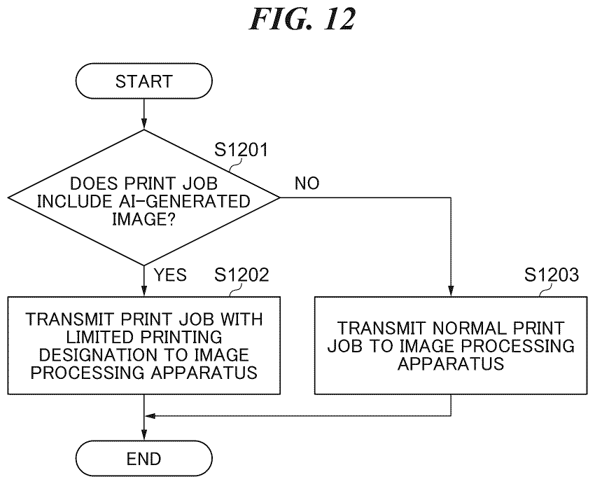

FIG. 12 is a flowchart illustrating processing executed by the general-purpose terminal 102 (print job processing of limited printing for AI-generated images). As illustrated in FIG. 12, in step S1201, the CPU 301 of the general-purpose terminal 102 controls the terminal AI-based image identification unit to determine whether or not AI image data (AI-generated image) is included in a print job (whether or not document image data of the print job includes an AI-generated image). As a result of the determination in step S1201, in a case where it is determined that the print job includes AI image data, the processing proceeds to step S1202. On the other hand, as a result of the determination in step S1201, in a case where it is determined that the print job does not include AI image data, the processing proceeds to step S1203.

In step S1202, the CPU 301 transmits a print job including a limited printing designation and an AI-based identification result to the image processing apparatus 500 via the network I/F 209. As a result, the limited printing is performed by the image processing apparatus 500 (see step S805 of the flowchart illustrated in FIG. 8). After execution of step S1202, the processing ends.

In step S1203, the CPU 301 transmits a print job that includes a normal printing designation and does not include an AI-generated image to the image processing apparatus 500 via the network I/F 305. As a result, the normal printing is performed by the image processing apparatus 500 (see step S803 of the flowchart shown in FIG. 8). After execution of step S1203, the processing ends.

In the present embodiment, the image processing system 10 has a configuration in which the image processing unit 609 is included in the image processing apparatus 500, but may have a configuration in which, for example, an image processing unit having a function similar to that of the image processing unit 609 (hereinafter referred to as “terminal image processing unit”) is included in the general-purpose terminal 102. Here, a description will be given mainly of the differences from the above-described configuration in which the image processing unit 609 is included in the image processing apparatus 500, and similar matters will be omitted from the description.

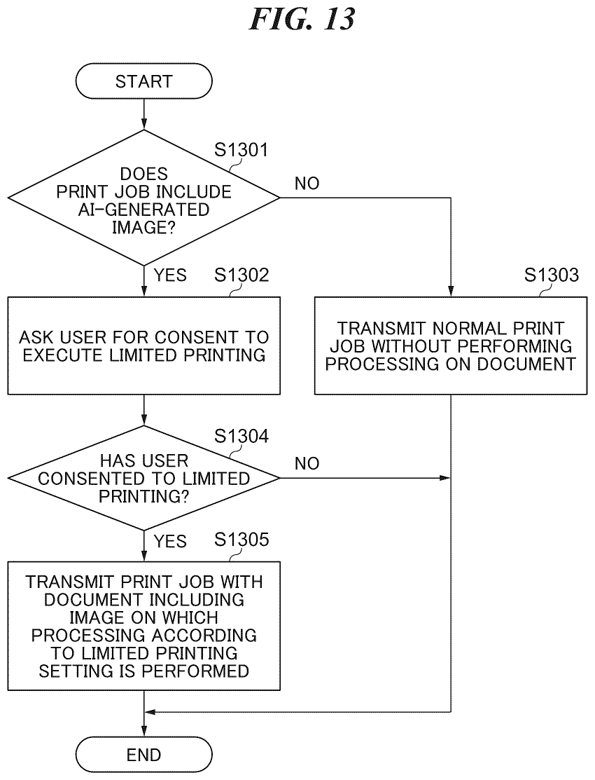

FIG. 13 is a flowchart illustrating a modification of the processing executed by the general-purpose terminal 102 (print job processing of limited printing for AI-generated images). As illustrated in FIG. 13, in step S1301, the CPU 301 of the general-purpose terminal 102 controls the terminal AI-based image identification unit to determine whether or not AI image data is included in a print job (whether or not document image data of the print job includes an AI-generated image). As a result of the determination in step S1301, in a case where it is determined that the print job includes AI image data, the processing proceeds to step S1302. At this time, the identification information is stored in the SSD 303. On the other hand, as a result of the determination in step S1301, in a case where it is determined that the print job does not include AI image data, the processing proceeds to step S1303.

In step S1303, the CPU 301 transmits a print job that includes a normal printing designation and does not include an AI-generated image to the image processing apparatus 500 via the network I/F 305. In this case, processing on an AI-generated image of the print job by the terminal image processing unit is omitted. Thus, the normal printing is performed by the image processing apparatus 500. After execution of step S1303, the processing ends.

In step S1302, the CPU 301 notifies a user using the general-purpose terminal 102 that an AI-generated image is included in the document to be printed, and notifies whether to perform the limited printing or to stop the printing. This notification is performed by displaying the notification screen 900 illustrated in FIG. 9 on a touch panel or the like of the user I/F 304. Note that information used for display of the notification screen 900 illustrated in FIG. 9 is obtained with reference to the identification information stored in the SSD 303 in step S1301.

In step S1304, the CPU 301 determines whether or not the proceed with limited printing button 906 has been operated on the notification screen 900 displayed in step S1302. As a result of the determination in step S1304, in a case where it is determined that the proceed with limited printing button 906 has been operated, the processing proceeds to step S1305. On the other hand, as a result of the determination in step S1304, in a case where it is determined that the proceed with limited printing button 906 has not been operated, that is, the stop printing button 905 has been operated, the printing processing (output processing) is not executed, and the processing ends.

In step S1305, the CPU 301 refers to the identification information stored in the SSD 303 and an output pattern setting for the limited printing. Then, the CPU 301 controls the terminal image processing unit to perform image processing of adding processing according to the output pattern setting to the AI-generated image portion included in the document image. Thereafter, the CPU 301 transmits a print job including the image data on which the image processing is performed to the image processing apparatus 500 via the network I/F 305. Thus, with the image processing apparatus 500, a printed matter is obtained on which the same image as the preview image 903 is printed. After execution of step S1305, the processing ends.

### Second Embodiment

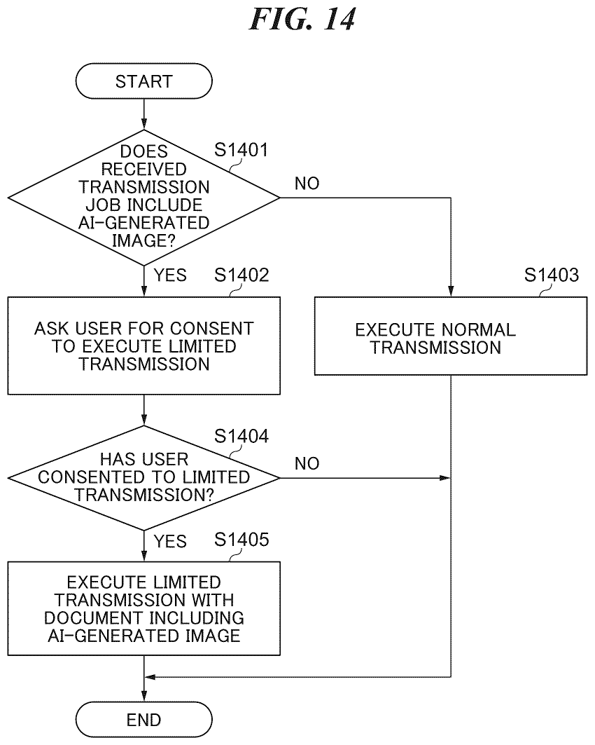

Hereinafter, a second embodiment will be described with reference to FIGS. 14 to 19. The description will be given mainly of the differences from the above-described embodiment, and similar matters will be omitted from the description. The present embodiment is similar to the first embodiment except for the output processing of the image processing apparatus 500. Specifically, as the output processing of outputting image data in the present embodiment, the present embodiment employs transmission processing of transmitting image data to an apparatus other than the image processing apparatus 500, that is, an apparatus (for example, the general-purpose terminal 102) different from the image processing apparatus 500. Furthermore, in the present embodiment, the network I/F 610 of the image processing apparatus 500 functions as an output unit capable of performing transmission processing.

FIG. 14 is a flowchart illustrating processing executed by the image processing apparatus 500 (processing of limited transmission for AI-generated images) according to the second embodiment. When a transmission job transmitted from an external apparatus such as the general-purpose terminal 102 via the network 100 is received by the network I/F 610, the image processing apparatus 500 starts execution of the transmission job. The transmission job includes information to be used by the image processing apparatus 500 to perform printing, such as the output size and resolution, as well as image data.

In step S1401, the CPU 601 (controller unit 503) of the image processing apparatus 500 controls the AI-based image identification unit 608 to determine whether or not AI image data (AI-generated image) is included in the transmission job received by the network I/F 610 (whether or not document image data of the transmission job includes an AI-generated image). Specifically, after execution of input processing of inputting the image data of the transmission job, the AI-based image identification unit 608 refers to metadata of image data as a determination target in the transmission job and performs image analysis to determine whether or not the image data includes identification information that indicates whether or not the image data is AI image data. In a case where the image data includes identification information, the AI-based image identification unit 608 determines that the transmission job includes AI image data. In a case where the image data does not include identification information, the AI-based image identification unit 608 determines that the transmission job does not include AI image data. Then, as a result of the determination in step S1401, in a case where it is determined that the transmission job includes AI image data, the processing proceeds to step S1402. At this time, the identification information is stored in the storage unit 603. On the other hand, as a result of the determination in step S1401, in a case where it is determined that the transmission job does not include AI image data, the processing proceeds to step S1403.

In step S1403, the CPU 601 executes a transmission job, that is, executes normal transmission processing assuming that a document including no AI-generated image is input. After execution of step S1403, the processing ends.

In step S1402, the CPU 601 notifies a user who uses the image processing apparatus 500 that an AI-generated image is included in the document to be transmitted, and notifies whether to perform the limited transmission or to stop the transmission.

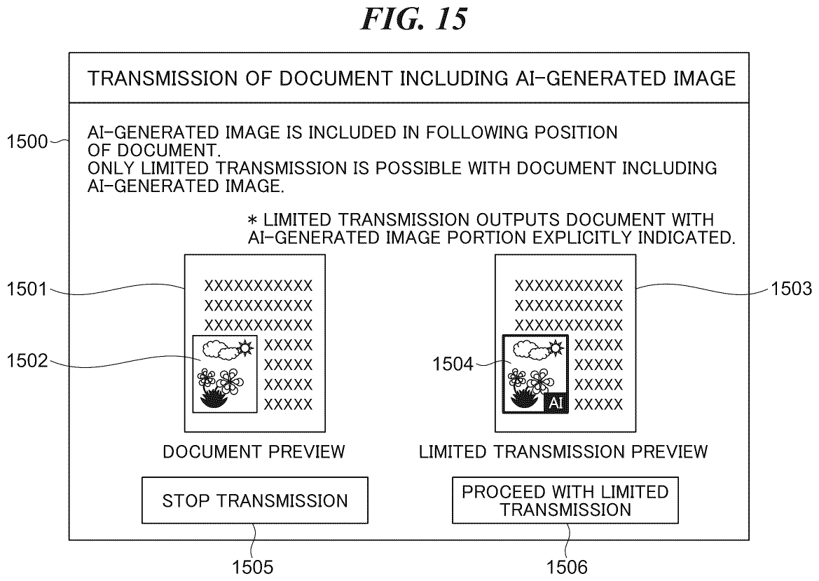

FIG. 15 is a diagram illustrating an example of a notification screen displayed on the image processing apparatus 500. A notification screen 1500 illustrated in FIG. 15 is displayed on the touch panel of the operation unit 607. The notification screen 1500 includes a preview image 1501, a preview image 1503, a stop transmission button 1505, and a proceed with limited transmission button 1506. The preview image 1501 is an image representing a document image as it is. The preview image 1501 includes a partial image 1502 that is an AI-generated image. The preview image 1503 is an image indicating a print result prediction when limited transmission is performed.

The preview image 1503 includes a partial image 1504 that is an AI-generated image. The partial image 1504 includes an image frame and characters of “AI” superimposed thereon as information indicating that it is an AI-generated image. This allows users to understand that, when image data that is a limited transmission target is printed, it provides a printed matter on which the same image as the preview image 1503 is printed.

In step S1404, the CPU 601 determines whether or not the proceed with limited transmission button 1506 of the notification screen 1500 displayed in step S1402 has been operated. As a result of the determination in step S1404, in a case where it is determined that the proceed with limited transmission button 1506 has been operated, the processing proceeds to step S1405. On the other hand, as a result of the determination in step S1404, in a case where it is determined that the proceed with limited transmission button 1506 has not been operated, that is, the stop transmission button 1505 has been operated, the transmission processing (output processing) is not executed, and the processing ends.

In step S1405, the CPU 601 controls the network I/F 610 to perform limited transmission. Specifically, the CPU 601 refers to the identification information stored in the storage unit 603 and an output pattern setting for the limited transmission. Then, the CPU 601 controls the image processing unit 609 to perform image processing of adding processing according to the output pattern setting to the AI-generated image portion included in the document image. Thereafter, the CPU 601 transmits a transmission job including the image data on which the image processing is performed to an apparatus other than the image processing apparatus 500 via the network I/F 610. After execution of step S1405, the processing ends.

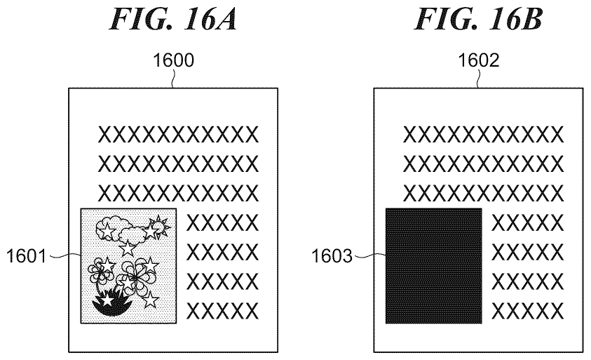

FIGS. 16A and 16B are diagrams illustrating an example of a printed matter printed by a printing apparatus in a case where the apparatus other than the image processing apparatus is the printing apparatus. In a printed matter 1600 illustrated in FIG. 16A, a partial image 1601 that is an AI-generated image has a very light color on the entire image, and has marks such as stars superimposed on the image, for example. With such image processing, viewers of the printed matter 1600 can understand that the partial image 1601 is an AI-generated image. In a printed matter 1602 illustrated in FIG. 16B, the partial image 1603, which is an AI-generated image, is an image filled in black. With such image processing, viewers of the printed matter 1602 can understand that the printed matter 1602 is a printed matter including an AI-generated image.

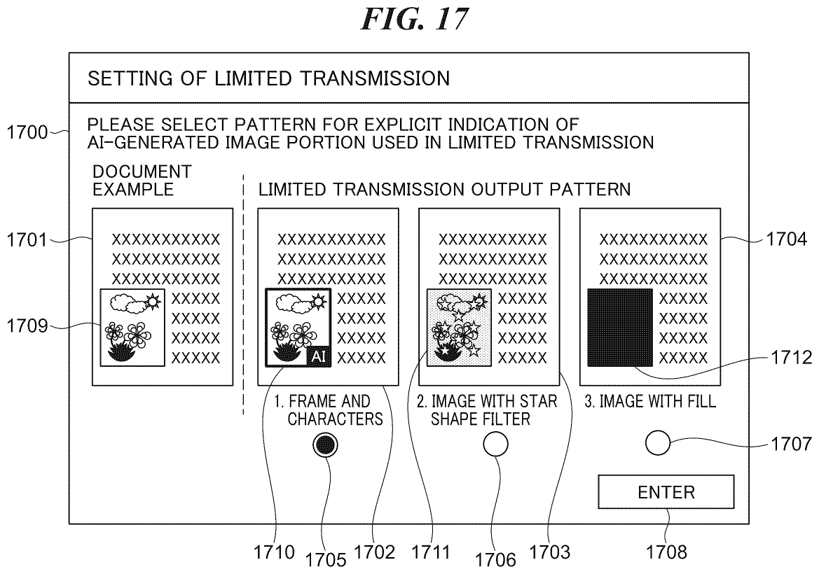

FIG. 17 is a diagram illustrating an example of an operation screen displayed on the image processing apparatus at the time of limited transmission. An operation screen 1700 illustrated in FIG. 17 is displayed on the touch panel of the operation unit 607. The operation screen 1700 includes preview images 1701 to 1704, radio buttons 1705 to 1707, and an enter button 1708.

The preview image 1701 is an image representing a document image as it is. The preview image 1701 includes a partial image 1709 that is an AI-generated image. The preview image 1702 is an image (first output pattern) indicating a print result prediction at a transmission destination in a case where limited transmission is performed. The preview image 1702 includes a partial image 1710 that is an AI-generated image. The partial image 1710 is similar to the partial image 1504. The preview image 1703 is an image (second output pattern) indicating a print result prediction at the transmission destination in a case where limited transmission is performed. The preview image 1703 includes a partial image 1711 that is an AI-generated image. The partial image 1711 is similar to the partial image 1601. The preview image 1704 is an image (third output pattern) indicating a print result prediction at the transmission destination in a case where limited transmission is performed. The preview image 1704 includes a partial image 1712 that is an AI-generated image. The partial image 1712 is similar to the partial image 1603.

The radio button 1705 is selected by a user when it is desired to obtain a printed matter on which the same image as the preview image 1702 is printed. The radio button 1706 is selected by a user when it is desired to obtain a printed matter on which the same image as the preview image 1703 is printed. The radio button 1707 is selected by a user when it is desired to obtain a printed matter on which the same image as the preview image 1704 is printed. A user is allowed to select one of the radio buttons 1705 to 1707 and then operate the enter button 1708. Thus, a printed matter of the preview image corresponding to the radio button selected in the operation screen 1700 is obtained at the transmission destination in a case where the limited transmission is performed.

As described above, in the image processing apparatus 500 according to the present embodiment, input processing of inputting image data is executed, and then a determination whether or not the input image data is made by AI-based image generation is made by the AI-based image identification unit 608. A result of the determination by the AI-based image identification unit 608 can be a case where it is determined that the image data as a transmission processing (output processing) target is made by AI-based image generation or a case where it is determined that the image data is not generated by AI-based image generation. When it is necessary or requested to determine whether or not image data to be output is AI image data, the image processing apparatus 500 is capable of changing the transmission processing according to a result of the determination. Hereinafter, similarly to the first embodiment, a case where image data as a transmission processing target is determined as being generated by AI-based image generation is referred to as a “first case”, and a case where image data as a transmission processing target is determined as not being generated by AI-based image generation is referred to as a “second case”.

In the first case, the CPU 601 (controller unit 503) of the image processing apparatus 500 adds processing to image data as a transmission processing target, and outputs the processed image data via the network I/F 610, thereby execute the transmission processing. When adding the processing to the image data, the CPU 601 performs processing on the image data so as to visualize that a printed matter acquired by the printing processing at the transmission destination is a printed matter of the image data including identification information. In other words, the CPU 601 performs processing on the image data so as to visualize that, when the image data transmitted by the transmission processing is printed, the image data includes the identification information in a printed matter of the image data. Thus, at the transmission destination, a printed matter is obtained on which, for example, the same image as the preview image 1503 (see FIG. 15) or the printed matter 1600 (see FIG. 16A) is printed. The partial image 1504 of the preview image 1503 includes the image frame and the characters of “AI” superimposed thereon. The partial image 1601 of the printed matter 1600 has very light color applied on the entire image, and has marks such as stars superimposed on the image. Alternatively, no transmission processing may be executed on an AI image portion. Thus, a printed matter is obtained on which, for example, the same image as the printed matter 1602 (see FIG. 16B) is printed. The partial image 1603 of the printed matter 1602 is an image filled with black. These kinds of printed matters make viewers aware that the printed matters include AI images. This gives viewers of the printed matters a way to, for example, suspect that the AI images may be fake.

It should be noted that, in the first case, the image processing apparatus 500 may be configured so as not to perform the limited transmission processing (output processing).

On the other hand, in the second case, the CPU 601 of the image processing apparatus 500 does not add the processing to the image data as a transmission processing target via the image processing unit 209, and performs the transmission processing on the image data as it is via the network I/F 609.

In the present embodiment, the image processing system 10 has a configuration in which the AI-based image identification unit 608 is included in the image processing apparatus 500, but may have a configuration in which, for example, a terminal AI-based image identification unit having a function similar to that of the AI-based image identification unit 608 is included in the general-purpose terminal 102. Here, a description will be given mainly of the differences from the above-described configuration in which the AI-based image identification unit 608 is included in the image processing apparatus 500, and similar matters will be omitted from the description.

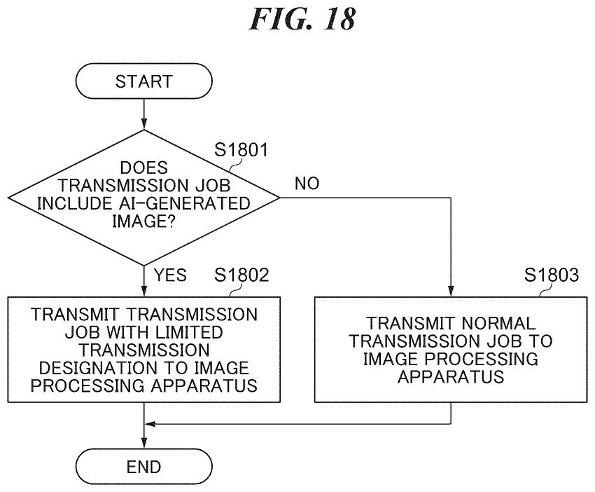

FIG. 18 is a flowchart illustrating processing executed by the general-purpose terminal (transmission job processing of limited transmission for AI-generated images). As illustrated in FIG. 18, in step S1801, the CPU 301 of the general-purpose terminal 102 controls the terminal AI-based image identification unit to determine whether or not AI image data (AI-generated image) is included in the transmission job (whether or not document image data of the transmission job includes an AI-generated image). As a result of the determination in step S1801, in a case where it is determined that the transmission job includes AI image data, the processing proceeds to step S1802. On the other hand, as a result of the determination in step S1801, in a case where it is determined that the transmission job does not include AI image data, the processing proceeds to step S1803.

In step S1802, the CPU 301 transmits a transmission job including a limited transmission designation and an AI-based identification result to, for example, the image processing apparatus 500 via the network I/F 209. As a result, the limited printing is performed by the image processing apparatus 500 (see step S805 of the flowchart shown in FIG. 8). After execution of step S1802, the processing ends.

In step S1803, the CPU 301 transmits a transmission job that includes a normal transmission designation and does not include an AI-generated image to, for example, the image processing apparatus 500 via the network I/F 305. As a result, the normal printing is performed by the image processing apparatus 500 (see step S803 of the flowchart shown in FIG. 8). After execution of step S1803, the processing ends.

In the present embodiment, the image processing system 10 has a configuration in which the image processing unit 609 is included in the image processing apparatus 500, but may have a configuration in which, for example, a terminal image processing unit having a function similar to that of the image processing unit 609 is included in the general-purpose terminal 102. Here, a description will be given mainly of the differences from the above-described configuration in which the image processing unit 609 is included in the image processing apparatus 500, and similar matters will be omitted from the description.

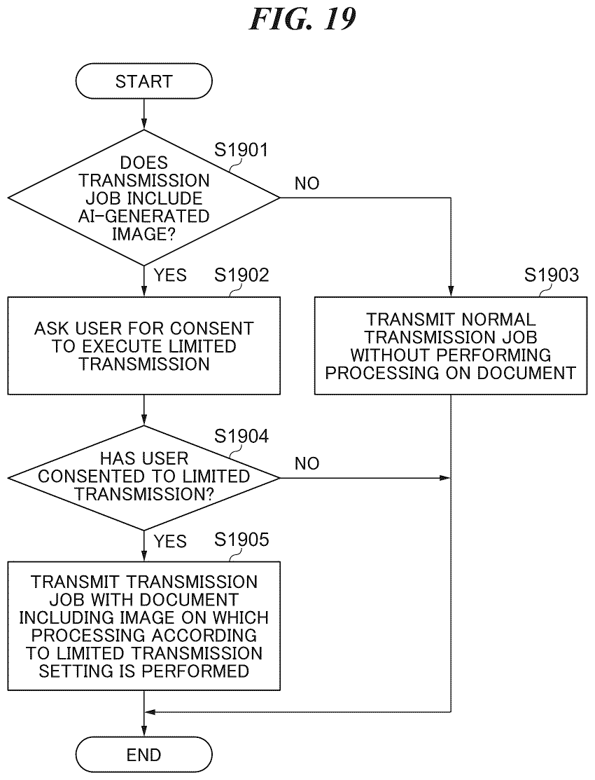

FIG. 19 is a flowchart illustrating a modification of the processing (transmission job processing of limited transmission for AI-generated images) executed by the general-purpose terminal 102. As illustrated in FIG. 19, in step S1901, the CPU 301 of the general-purpose terminal 102 controls the terminal AI-based image identification unit to determine whether or not AI image data is included in the transmission job (whether or not document image data of the transmission job includes an AI-generated image). As a result of the determination in step S1901, in a case where it is determined that the transmission job includes AI image data, the processing proceeds to step S1902. At this time, the identification information is stored in the SSD 303. On the other hand, as a result of the determination in step S1901, in a case where it is determined that the transmission job does not include AI image data, the processing proceeds to step S1903.

In step S1903, the CPU 301 transmits a transmission job that includes a normal transmission designation and does not include an AI-generated image to, for example, the image processing apparatus 500 via the network I/F 305. In this case, processing on an AI-generated image of the print job by the terminal image processing unit is omitted. Thus, the normal printing is performed by the image processing apparatus 500. After execution of step S1903, the processing ends.

In step S1902, the CPU 301 notifies a user using the general-purpose terminal 102 that an AI-generated image is included in the document to be transmitted, and notifies whether to perform the limited transmission or stop the transmission. This notification is performed by displaying a notification screen 900 illustrated in FIG. 15 on a touch panel or the like of the user I/F 304.

In step S1904, the CPU 301 determines whether or not the proceed with limited transmission button 1506 has been operated on the notification screen 900 displayed in step S1902. As a result of the determination in step S1904, in a case where it is determined that the proceed with limited transmission button 1506 has been operated, the processing proceeds to step S1905. On the other hand, as a result of the determination in step S1904, in a case where it is determined that the proceed with limited transmission button 1506 has not been operated, that is, the stop transmission button 1505 has been operated, the transmission processing (output processing) is not executed, and the processing ends.

In step S1905, the CPU 301 refers to the identification information stored in the SSD 303 and an output pattern setting for the limited transmission. Then, the CPU 301 controls the terminal image processing unit to perform image processing of adding processing according to the output pattern setting to the AI-generated image portion included in the document image. Thereafter, the CPU 301 transmits a transmission job including the image data on which the image processing is performed to, for example, the image processing apparatus 500 via the network I/F 305. Thus, with the image processing apparatus 500, a printed matter is obtained on which the same image as the preview image 1503 is printed. After execution of step S1905, the processing ends.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

In addition, in the above embodiments, image data which is an output processing target is transmitted from the AI-based image generation server 101 to the image processing apparatus 500 via the general-purpose terminal 102 and then subjected to input processing through the network I/F 610 and the CPU 601 of the image processing apparatus 500, but is not limited thereto. For example, the image data which is an output processing target may be read by the image reading unit 502 of the image processing apparatus 500 as input processing. In this case, it is preferable that the image data is determined whether or not the image data is an AI image by, for example, analysis or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-006580, filed Jan. 19, 2024, which is hereby incorporated by reference wherein in its entirety.

What is claimed is:

1. An image processing apparatus comprising:
an input unit configured to execute input processing of inputting image data;
a determination unit configured to make a determination whether or not the image data input by the input processing is generated on a basis of a learning model; and
an output unit configured to
not execute output processing of outputting the image data in a case where it is determined by the determination unit that the image data is generated on a basis of the learning model, and
execute the output processing in a case where it is determined by the determination unit that the image data is not generated on a basis of the learning model.

2. The image processing apparatus according to claim 1, wherein the output processing is printing processing of printing the image data.

3. The image processing apparatus according to claim 1, wherein the output processing is transmission processing of transmitting the image data to an apparatus different from the image processing apparatus.

4. The image processing apparatus according to claim 1,
wherein the determination unit makes the determination on a basis of whether or not the image data includes identification information identifying the image data as being generated on a basis of the learning model.

5. The image processing apparatus according to claim 4,
wherein the determination unit determines that the image data is generated on a basis of the learning model in a case where the image data includes the identification information, and determines that the image data is not generated on a basis of the learning model in a case where the image data does not include the identification information.

6. The image processing apparatus according to claim 4,
wherein the identification information is digitized, and
the determination unit determines that the image data is generated on a basis of the learning model in a case where a numerical value of the identification information is equal to or greater than a threshold value, and determines that the image data is not generated on a basis of the learning model in a case where the numerical value of the identification information is less than the threshold value.

7. The image processing apparatus according to claim 1,
wherein the image processing apparatus is communicably connected to an external apparatus configured to transmit the image data to the image processing apparatus, and
the output unit executes the output processing on the image data input through the input unit from the external apparatus.

8. An image processing apparatus comprising:
an input unit configured to execute input processing of inputting image data;
a determination unit configured to make a determination whether or not the image data input by the input processing is generated on a basis of a learning model;
a processing unit configured to add processing to the image data in a case where it is determined that the image data-is generated on a basis of the learning model; and
an output unit configured to execute output processing of outputting the image data to which the processing is added.

9. The image processing apparatus according to claim 8, wherein the output processing is printing processing of printing the image data.

10. The image processing apparatus according to claim 9,
wherein in a case where the image data includes identification information identifying the image data as being generated on a basis of the learning model, the processing unit adds processing on the image data to visualize that the image data includes the identification information in a printed matter of the image data acquired by the printing processing.

11. The image processing apparatus according to claim 8, wherein the output processing is transmission processing of transmitting the image data to an apparatus different from the image processing apparatus.

12. The image processing apparatus according to claim 11,
wherein in a case where the image data includes identification information identifying the image data as being generated on a basis of the learning model, the processing unit adds processing on the image data to visualize that, when the image data transmitted by the transmission processing is printed, the image data includes the identification information in a printed matter of the image data.

13. The image processing apparatus according to claim 8,
wherein in a case where it is determined by the determination unit that the image data is not generated on a basis of the learning model, the output unit outputs the image data without the processing unit adding processing to the image data.

14. The image processing apparatus according to claim 8,
wherein the determination unit makes the determination on a basis of whether or not the image data includes identification information identifying the image data as being generated on a basis of the learning model.

15. The image processing apparatus according to claim 8,
wherein the image processing apparatus is communicably connected to an external apparatus configured to transmit the image data to the image processing apparatus, and
the output unit executes the output processing on the image data input through the input unit from the external apparatus.

16. A method for controlling an image processing apparatus, the method comprising:
executing input processing of inputting image data;
determining whether or not the image data input by the input processing is generated on a basis of a learning model;
not executing output processing of outputting the image data in a case where it is determined that the image data is generated on a basis of the learning model; and
executing the output processing in a case where it is determined that the image data is not generated on a basis of the learning model.

17. A method for controlling an image processing apparatus, the method comprising:
executing input processing of inputting image data;
determining whether or not the image data input by the input processing is generated on a basis of a learning model; and
in a case where it is determined that the image data generated on a basis of the learning model, adding processing to the image data and executing output processing of outputting the image data to which the processing is added.

18. A computer-readable non-transitory storage medium storing a program for causing a computer to execute a method for controlling an image processing apparatus, the method comprising:
executing input processing of inputting image data;
determining whether or not the image data input by the input processing is generated on a basis of a learning model;
not executing output processing of outputting the image data in a case where it is determined that the image data is generated on a basis of the learning model; and
executing the output processing in a case where it is determined that the image data is not generated on a basis of the learning model.

19. A computer-readable non-transitory storage medium storing a program for causing a computer to execute a method for controlling an image processing apparatus, the method comprising:
executing input processing of inputting image data;
determining whether or not the image data input by the input processing is generated on a basis of a learning model; and
in a case where it is determined that the image data generated on a basis of the learning model, adding processing to the image data and executing output processing of outputting the image data to which the processing is added.
